(19) United States
(12) Patent Application Publication
(10) Pub. No.: US 2020/0028170 A1
(43) Pub. Date: Jan. 23, 2020

(54) ENGINEERING ENERGY STORAGE DEVICES BY CONTROLLING DEFECTS IN CARBON-BASED ELECTRODES

(71) Applicant: New York University, New York, NY (US)

(72) Inventors: Ting Wu, Brooklyn, NY (US); Abdullah Alharbi, Brooklyn, NY (US); Roozbeh Kiani, New York, NY (US); Davood Shahrjerdi, New York, NY (US)

(21) Appl. No.: 16/220,743

(22) Filed: Dec. 14, 2018

Related U.S. Application Data
(60) Provisional application No. 62/599,310, filed on Dec. 15, 2017.

(51) Int. Cl. H01M 4/583; H01G 11/36; G06F 17/50

(52) U.S. Cl. CPC H01M 4/583; H01G 11/36; H01M 2004/021; G06F 2217/16; G06F 17/5009

(57) ABSTRACT

An energy storage device containing a carbon-based electrode composed of graphitic film having a density of specific types of structural defects is explained. The carbon-based electrode may be used as an electrode in a supercapacitor or as an anode layer of a rechargeable battery. A distributed model is developed that predicts the area-normalized apparent capacitance from the density of point and line defects in the graphitic film. From this model, one can engineer the apparent capacitance by controlling the density of point and line defects.

### CROSS REFERENCE TO RELATED APPLICATION

The present invention claims the benefit of U.S. Provisional Patent Application No. 62/599,310 filed Dec. 15, 2017, the entire content and disclosure of which is incorporated herein by reference.

### STATEMENT REGARDING FEDERALLY SPONSORED RESEARCH OR DEVELOPMENT

This invention was made with government support under grant number DE-SC0012704 awarded by the Department of Energy and grant number NSF-CMMI award 1728051 awarded by the National Science Foundation. The government has certain rights in the invention.

### FIELD OF THE INVENTION

The present disclosure relates to an energy storage device containing a carbon-based electrode that is composed of a graphitic film having a density of a specific type of structural defects.

### BACKGROUND

In recent years there has been an increased demand for energy storage devices such as, for example, rechargeable batteries and supercapacitors, that have high-capacity and exhibit increased energy storage capability. A supercapacitor has much higher capacitance than ordinary capacitors, typically stores 10 to 100 times more energy per unit volume or mass than electrolytic capacitors, can accept and deliver charge much faster, and can tolerate numerous charge and discharge cycles.

Unlike ordinary capacitors, supercapacitors do not use the conventional solid dielectric, but rather, they use electrical double-layer capacitance and electrochemical pseuocapacitance, both of which contribute to the total capacitance of the capacitor, with a few differences. For example, electrical double-layer capacitors use carbon-based or derivatives with much higher electrical double-layer capacitance than electrochemical pseudocapacitance, achieving separation of charge in a Helmholz double-layer at the interface between the surface of a conductive electrode and an electrolyte. The separation of charge is of the order of a few Angstroms, much smaller than in a conventional capacitor.

Improvements in terms of high-capacity and increased energy storage capability of such energy devices, i.e., supercapacititors and rechargeable batteries are sought.

### SUMMARY

The present disclosure relates to an energy storage device containing a carbon-based electrode that is composed of a graphitic film having a density of a specific type of structural defects. Notably, the carbon-based electrodes that are employed in the energy storage devices are composed of a graphitic film having a density of zero-dimensional defects (i.e., defects caused by atomic vacancies or doping in the carbon lattice) and a density of one-dimensional defects (i.e., defects caused by misfit dislocations, crystallite borders, etc). Zero-dimensional defects may also be referred to herein as “point defects” or “point-like defects”. One-dimensional defects may also be referred to herein as “line defects”. The graphitic films that can be employed in the present disclosure have sp² hybridization. By “sp² hybridization” it is meant that the 2s orbital of a carbon atom mixes with two of the three available 2p orbitals to create new hybrid orbitals that form chemical bonds between atoms (e.g., between carbon atoms in graphene).

In one embodiment, the graphitic films may be used as an electrode in a supercapacitor. In another embodiment, the graphitic films may be used as an electrode, i.e., anode layer, of a rechargeable battery.

### BRIEF DESCRIPTION OF THE DRAWINGS

FIG. 1 is a pictorial representation of a supercapacitor that can be employed in accordance with an embodiment of the present disclosure.

FIG. 2 is a pictorial representation of a material stack of a rechargeable battery that can be employed in accordance with an embodiment of the present disclosure.

FIG. 3 shows the schematic illustration of point and line defects in a graphitic material.

FIG. 4 shows the scanning electron microscopy image of graphitic test devices for capacitance measurements.

FIG. 5 shows the Raman analysis results for quantifying the density of point and line defects in multiple graphitic films with different amounts of structural defects.

FIG. 6 shows the examples of background current for two graphitic test structures, which is produced due to charging and discharging of the apparent capacitance; the capacitance was extracted using the amplitude of the current at the green marks.

FIG. 7 shows a distributed electrical model that links the apparent capacitance to the point and line defects.

FIG. 8 plots apparent capacitance as a function of N_{D}, which is related to the density of point and line defects in graphitic films that are in stage (i).

### DETAILED DESCRIPTION

The present disclosure will now be described in greater detail by referring to the following discussion and drawings that accompany the present disclosure. It is noted that the drawings of the present disclosure are provided for illustrative purposes only and, as such, the drawings are not drawn to scale. It is also noted that like and corresponding elements are referred to by like reference numerals.

In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details. In other instances, well-known structures or processing steps have not been described in detail in order to avoid obscuring the present disclosure.

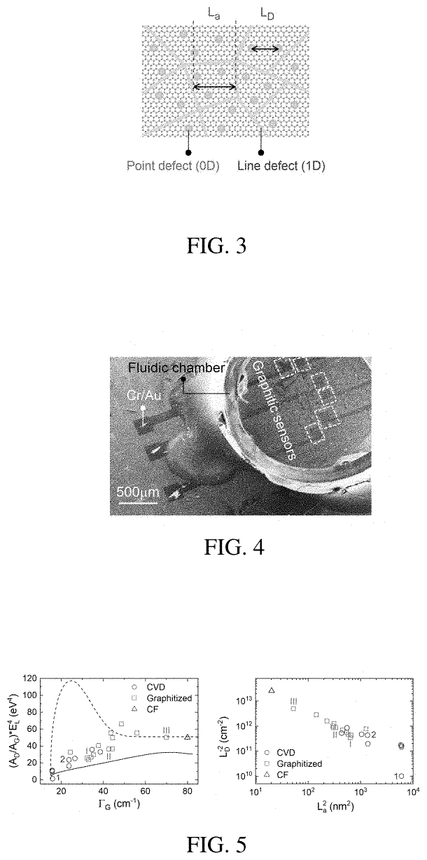

In the present disclosure, graphitic films, as defined herein, are employed due to (i) their important technological relevance, and (ii) ease of defect engineering. The findings of this disclosure are applicable to other sp²-hybridized carbon materials, e.g., carbon nanotubes and graphene oxide. In the present disclosure, the graphitic films have different amounts of zero-dimensional defects and one-dimensional defects (FIG. 3) quantified using Raman spectroscopy. FIG. 5 shows the Raman analysis results for quantifying the density of point and line defects in multiple graphitic films with different amounts of structural defects. Zero-dimensional defects often referred to as “point defects” or “point-like defects” include, for example, vacancies and doping. One-dimensional defects often referred to as line defects include, for example, crystallite borders or misfit dislocations.

The graphitic films that are employed in the present disclosure have sp² hybridization, as defined above. The graphitic films of the present disclosure have sp² type defects. In accordance with the present disclosure, the sp² type defects consist of single, complex vacancies, or other sub-types of point defects that locally increase the density of states (DOS) in the electronic band structure of graphene at the Dirac energy. An example of such point defects includes incorporating nitrogen in Stone-Wales defects. In some embodiments, the graphitic film that can be employed in the present disclosure is composed of a multilayer graphene film. In some embodiments, the crystal size of the graphene (i.e., the length of the aromatic carbon chain) within the multilayer graphene film can range from 2 nm to 1 μm. In some embodiments, the graphitic films may be undoped or doped with an n-type or p-type dopant. The graphitic film that can be used in the present disclosure has a porous structure for increasing the total surface area.

In some embodiments, the graphitic film that is employed is in stage (i) of the amorphization trajectory of graphene. In some embodiments, the graphitic film is composed of a fully disordered sp² carbon material and containing a density of zero-dimensional and one-dimensional defects. In such an embodiment, the carbon material is in stage (ii) of the graphene amorphization trajectory.

The graphitic films of the present application may also contain one-dimensional defects (line defects). The density of these defects defines the size of graphene crystallites. In some embodiments, the graphitic film may have a point defect density in the range of about 10¹⁰ to about 4-5×10¹² cm⁻². In some embodiments, the graphitic film may have a line defect density in the range of about 10¹⁰ to about 1×10¹³ cm⁻². In other embodiments, the graphitic film that is employed has a maximum area-normalized apparent capacitance that is achieved when the graphitic material is in stage (i) and has a point defect density of about 4-5×10¹² cm⁻² and a line defect density of about 2-4×10¹² cm².

In another embodiment, the starting graphitic electrode may be in stage (ii) of the amorphization trajectory of graphene, hence consisting of point and line defect densities that are higher than the optimal densities for achieving the maximum capacitance. Additional processing steps such as furnace annealing, microwave annealing, or any process that can yield thermal energy may be used for tailoring the structural properties of the graphitic film. By subjecting the graphitic electrode, that is in stage (ii), to such a process, the overall density of defects in the lattice structure is reduced to an optimal density of about 4-5×10¹² cm⁻² for point defects and a density of about 2-4×10¹² cm⁻² for line defects.

The amount of point and line defects determines the graphitic film structure, which can be engineered between highly-ordered multilayer graphene (no defects) to a disordered nanocrystalline graphite (numerous point and line defects without total loss of crystalline structure). In some embodiments, the density of point defects of the graphitic film is below the threshold in which the film structure changes to a fully disordered sp² carbon in which the crystalline structure disappears.

The graphitic films of the present disclosure can be formed utilizing chemical vapor deposition (CVD) or metal-induced transformation of amorphous carbon. In the metal-induced transformation of amorphous carbon, an amorphous carbon film (which lacks any large range order of crystal structure) can be formed by a deposition process such as, for example, sputtering or evaporation. In some embodiments, the amorphous carbon film can be derived from a polymeric film. After forming the amorphous carbon film, a metal catalyst can be formed on the amorphous carbon film. The metal catalyst that can be used in the present disclosure includes, but is not limited to, nickel (Ni), cobalt (Co) or copper (Cu). The metal catalyst can be formed utilizing a deposition process such as, for example, plating, sputtering, vaporizing the metal during the graphitization step, or a combination thereof. The metal catalyst may have a thickness from 0.2 nm to 200 nm. Next, an annealing process is performed to convert the amorphous carbon film into a multilayer graphene film. This annealing may be performed in vacuum or under an ambient such as nitrogen, argon, or hydrogen. The carrier gas may contain doping impurities such as ammonia, etc. In one embodiment, the annealing can be performed at a temperature greater than 900° C. In another embodiment, the annealing can be performed at a temperature from 600° C. to 1600° C.

After providing the multilayer graphene film (either by CVD or metal-induced transformation of amorphous carbon), the multilayer graphene film can be patterned into a carbon-based electrode having a desired electrode shape and size utilizing existing nanopatterning processes that are compatible with silicon-based technologies. That is, the graphitic films, i.e., the multilayer graphene film, can be patterned into a desired electrode shape and size utilizing lithography and etching. In one example, the patterning may be performed utilizing electron-beam lithography. FIG. 4 shows a test structure produced through nanofabrication for testing the apparent capacitance of the graphitic films.

The carbon-based electrode can be used in various energy storage devices including, but not limited to, supercapacitors and rechargeable batteries. Energy storage devices containing the graphitic film of the present application may achieve high-capacity and increased energy storage capability.

The process for producing the graphitic material and subsequently manufacturing a supercapacitor or battery from the material are not limited to the processes described above. Specifically, the structural optimization taught in this disclosure is independent of the production methods for making these devices. The key to achieving the maximum capacitance, however, is to tailor the material structure on the atomic level according to the teaching of this disclosure. Moreover, the structural optimization of the graphitic electrode may take place at any point during the supercapacitor or battery production, which may differ from one manufacturing approach to another.

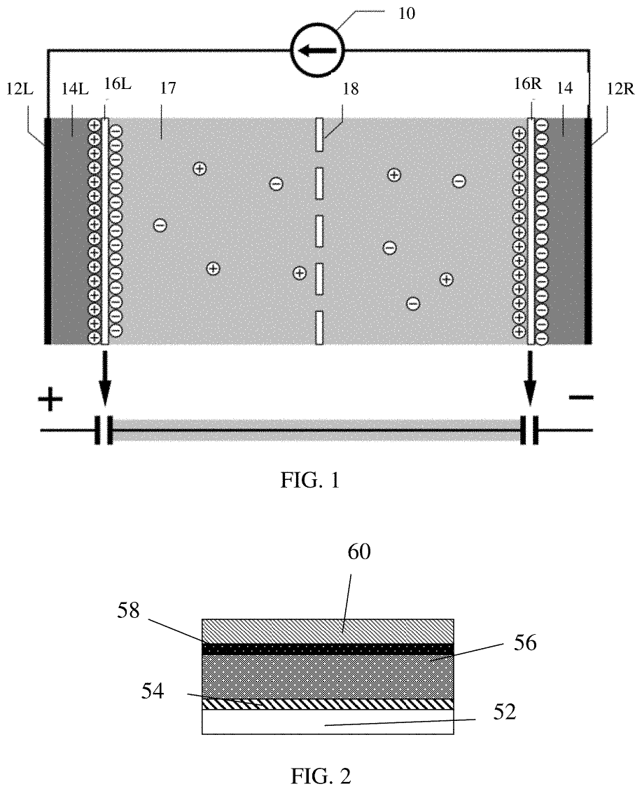

FIG. 1 illustrates a supercapacitor that can be employed in accordance with an embodiment of the present disclosure. As illustrated, the supercapacitor of FIG. 1 includes a power source 10, current collectors 12L, 12R, polarized electrodes 14L, 14R which can provide Helmholtz double-layers 16L, 16R, an electrolyte 17 and a separator 18. At least one of the polarized electrodes 14L, 14R includes a carbon-based electrode, i.e., graphitic film, of the present disclosure.

The current collectors 12R, 12L of the supercapacitor shown in FIG. 1 may include any conductive metal or metal alloy such as, for example, titanium (Ti), platinum (Pt), nickel (Ni), aluminum (Al), or titanium nitride (TiN). The current collectors 12R, 12L may be single layered or multilayered. In some embodiments, current collector 12L may be composed of a same conductive metal or metal alloy as current collector 12R. In other embodiments, current collector 12L may be composed of a different conductive metal or metal alloy than current collector 12R.

In some embodiments, both polarized electrodes 14L, 14R are composed of a carbon-based electrode in accordance with the present application. In another embodiment, one of the polarized electrodes is composed of the carbon-based electrode of the present application, while another of the polarized electrode is composed of a different material such as, for example, a carbon nanotube, a carbon aerogel, activated carbon, activated carbon fibers, or carbide-derived carbon.

The electrolyte 17 may include any conventional liquid electrolyte that is typically used in such a storage device or emerging ionic-liquid electrolytes. Membrane 18 may include any membrane material such as, for example, a flexible porous material, a gel, or a sheet that is composed of cellulose, cellophane, polyvinyl acetate (PVA), PVA/cellulous blends, polyethylene (PE), polypropylene (PP) or a mixture of PE and PP. The separator may also be composed of inorganic insulating nano/microparticles.

Referring now to FIG. 2, there is shown a material stack of a rechargeable battery that can be employed in accordance with an embodiment of the present disclosure. The rechargeable battery of FIG. 2 includes a cathode current collector 52, a cathode layer, 54, an electrolyte 56, anode layer 58, and an anode current collector 60. Although the present disclosure describes and illustrates the cathode current collector 52 being the bottommost element of the material stack of the rechargeable battery and the anode current collector 60 being the topmost element of the material stack of the rechargeable battery, one skilled in the art realizes that the material stack may have other orientations such as, for example, be flipped 180°, or rotated 90°.

Cathode current collector 52 may include any conductive metal or metal alloy such as, for example, titanium (Ti), platinum (Pt), nickel (Ni), aluminum (Al), or titanium nitride (TiN). The cathode current collector 52 may be single layered or multilayered.

The cathode layer 54 is composed of any cathode material that is employed in a rechargeable battery. In one embodiment, the cathode layer 54 is composed of a lithiated material such as, for example, a lithium-based mixed oxide. Examples of lithium-based mixed oxides that may be employed as include, but are not limited to, lithium cobalt oxide (LiCoO₂), lithium nickel oxide (LiNiO₂), lithium manganese oxide (LiMn₂O₄), lithium cobalt manganese oxide (LiCoMnO₄), a lithium nickel manganese cobalt oxide (LiNiₓMn_{y}Co_{z}O₂), lithium vanadium pentoxide (LiV₂O₅) or lithium iron phosphate (LiFePO₄).

The electrolyte 56 may include any conventional electrolyte material. The electrolyte 56 may be a liquid electrolyte, an ionic-liquid electrolyte, a solid-state electrolyte or a gel type electrolyte. In some embodiments, a solid-state electrolyte may be employed that is composed of a polymer based material or an inorganic material. In other embodiments, a solid-state electrolyte may be employed that includes a material that enables the conduction of lithium ions. Such materials may be electrically insulating, but ionic conducting. Examples of materials that can be employed as a solid-state electrolyte include, but are not limited to, lithium phosphorus oxynitride (LiPON) or lithium phosphosilicate oxynitride (LiSiPON).

In embodiments in which a liquid electrolyte is used, a separator (not shown) can be present in a region of the electrolyte to provide different electrolyte regions or zones. Examples of separators that may be employed include one or more of a flexible porous material, a gel, or a sheet that is composed of cellulose, cellophane, polyvinyl acetate (PVA), PVA/cellulous blends, polyethylene (PE), polypropylene (PP) or a mixture of PE and PP. The separator may also be composed of inorganic insulating nano/microparticles.

The anode layer 58 is composed of the carbon-based electrode of the present application. That is the anode layer 58 is composed of a graphitic film having sp² hydridization and a density of point and line defects.

Anode current collector 60 may include one of the conductive metals or metal alloys mentioned above for the cathode current collector 52. The conductive metal or metal alloy that provides the anode current collector 60 may be the same as, or different, from the conductive metal or metal alloy that provides the cathode current collector 52.

### Examples

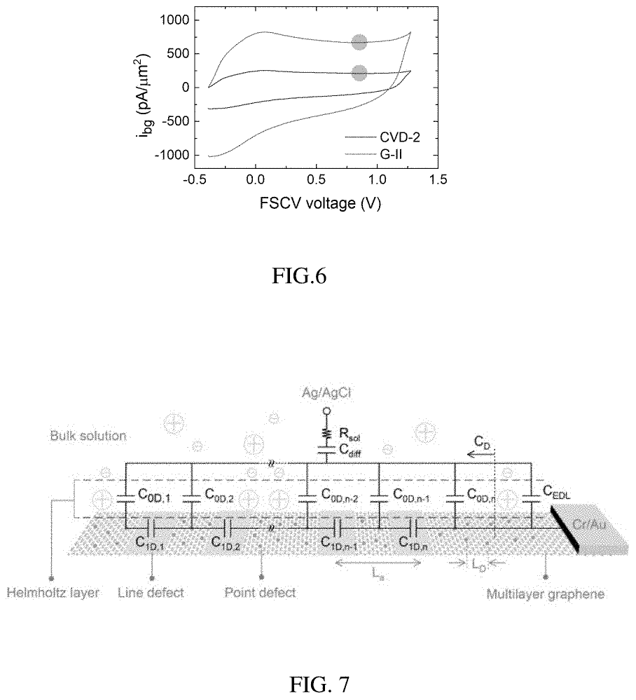

To reveal the link between the structural defects and the apparent capacitance of the graphitic electrodes, fast scan cyclic voltammetry (FSCV) measurements were performed. Using standard nanofabrication, miniaturized graphitic electrodes as shown in FIG. 4 were formed. A triangular voltage waveform was applied to the graphitic electrodes with a typical scan rate of 400 V/s. The voltage waveform produces a background current (i_{bg}) due to the charging and discharging of an apparent capacitance (Cₐₚ) at the interface between the electrode and the electrolyte solution. In the present disclosure, the electrolyte was a 1× phosphate buffered saline (PBS) solution. The purpose of these tests was to extract the value of the apparent capacitance. In FIG. 6, the background current characteristics of two graphitic electrodes are illustrated. In the analysis, the measured currents were normalized with respect to the corresponding surface area of the electrodes. To accurately determine the surface area, the surface roughness of the electrodes, measured by the atomic force microscopy, was accounted for. The value of the apparent capacitance at the flat region of the background current curves (marked with a circle in FIG. 6) was then estimated using i_{bg}=Cₐₚ×dV/dt, where dV/dt is the scan rate. This expression assumes that the series resistance and the diffusion capacitance of the PBS solution are negligible. These are reasonable assumptions due to the high concentration of PBS.

In these experiments, it was observed that the apparent capacitance depends on the concentration of both type of defects. Although past research, such as is described in the publication to H. Ji et al. entitled “Capacitance of carbon-based electrical double-layer capacitors”, Nat. Comm., 2014, DOI 10.1038/ncomms4317, has shown the increase of the capacitance by incorporating point defects (mainly via nitrogen doping), the effect of line defects has remained largely unknown. Specifically, the disclosed data in this disclosure show that the combination of point and line defects causes significant enhancement of the capacitance. The value of the resulting capacitance is noticeably larger than that for electrodes containing only point defects. Moreover, a simple model that can explain the significant increase of the capacitance due to the combined effects of point and line defects is nonexistent. This application discloses a distributed electrical model as shown in FIG. 7 that can predict the apparent capacitance of a graphitic electrode in stage (i) from its density of point and line defects. In this model, C_{0D,i} and C_{1D,i}, represent the capacitances due to the point defects and line defects associated with the i-th crystallite in the material. It is known that the local density of states (LDOS) in graphene increases at the defect sites. On the other hand, these capacitances are directly proportional to their corresponding LDOS. Since point defects are non-overlapping in stage (i), the net LDOS tends to increase in proportion to the concentration of defects. Considering the typical values for crystallite size (Lₐ) and distance between point defects (L_{D}) in graphitic films used for energy storage applications, the net capacitance due to defects, C_{D}, in the distributed model can be approximated with the series connection of C_{0D} and C_{1D}.

These are the total capacitances due to the point-like and line defects, and thus their values are proportional to the density of these defects, i.e., L_{D}⁻² and Lₐ⁻², respectively. Assuming similar LDOS for a point and a line defect, which is a reasonable assumption, we can write the following expression for C_{D}:

$${C}_{D} \approx {( \frac{1}{{C}_{0 D}} + \frac{1}{{C}_{1 D}} )}^{- 1} ∝ {( {L}_{D}^{2} + \frac{{L}_{a}^{2}}{2} )}^{- 1} = {N}_{D} \qquad ( 1 )$$

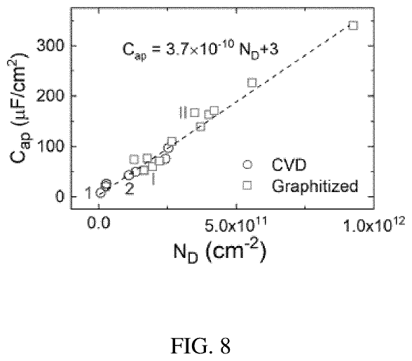

FIG. 8 shows a plot of the apparent capacitance for the graphitic devices, extracted from their measured i_{bg} data, as a function of N_{D}. The linear fit to the data indicates the ability of the electrical model provided herein to predict the apparent capacitance for graphitic films in stage (i). The intercept of the linear fit is 3 μF/cm², which corresponds to the electrical double layer capacitance (C_{EDL}) of pristine multilayer graphene (with no defects). This observation further confirms the validity of the model of the present disclosure.

This model is valid in stage (i) of the graphene amorphization trajectory and predicts that the area-normalized apparent capacitance increases by simultaneously increasing the density of point and line defects according to equation (1). The maximum capacitance can be achieved by maximizing the density of point and line defects before transitioning into stage (ii), where the electrode material becomes fully disordered sp² carbon. Upon this transition, the area-normalized capacitance decreases rapidly with increasing the density of defects.

In energy storage devices, the total capacitance is linearly proportional to the power density of the device. The total capacitance (Cₜₒₜ) is a product of the area-normalized capacitance (Cₐₚ) and the electrode area (A). The present disclosure teaches graphitic structures that can significantly enhance the area-normalized capacitance, which is inherent to the material structure. The graphitic structures disclosed in this disclosure can be simply combined with the state-of-the-art approaches for producing porous carbon films, which will increase the surface area (A) of the electrode. Further, different type electrolyte can be employed for further enhancing the storage density of the devices by allowing the increase of the operating voltage.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. An energy storage device comprising a carbon-based electrode composed of a graphitic film having sp² hybridization and a density of zero- and one-dimensional defects.

2. The energy storage device of claim 1, wherein the carbon-based electrode is a component of a supercapicator.

3. The energy storage device of claim 1, wherein the carbon-based electrode is a component of a rechargeable battery.

4. The energy storage device of claim 1, wherein the carbon-based electrode is n-doped, p-doped, or undoped.

5. The energy storage device of claim 1, wherein the graphitic film is in stage (i) of the amorphization trajectory of graphene.

6. The energy storage device of claim 5, wherein the graphitic film has a point defect density in the range of about 10¹⁰ to about 5×10¹² cm⁻².

7. The energy storage device of claim 5, wherein the graphitic film has a line defect density in the range of about 10¹⁰ to about 4×10¹² cm⁻².

8. The energy storage device of claim 1, wherein a maximum area-normalized apparent capacitance is achieved when the graphitic film is in stage (i) and has a point defect density of about 4×10¹² to about 5×10¹² cm⁻² and a line defect density of about 2×10¹² to about 4×10¹² cm⁻².

9. The energy storage device of claim 1, wherein the optimization of the defect densities in the electrode material structure occurs at any point during the electrode or device manufacturing.

10. The energy storage device of claim 1, wherein the graphitic film has a porous structure for increasing the total capacitance in proportion to the surface area.

11. An energy storage device comprising a carbon-based electrode composed of a fully disordered sp² carbon material and containing a density of zero-dimensional and one-dimensional defects.

12. The energy storage device of claim 11, wherein the carbon material is n-doped, p-doped, or undoped.

13. The energy storage device of claim 11, wherein the carbon material is in stage (ii) of the graphene amorphization trajectory.

14. The energy storage device of claim 11, wherein the carbon film has a point defect density in the range of about 4×10¹² to about 2×10¹³ cm⁻² and line defect density of about 4×10¹² cm⁻² or more.

15. The energy storage device of claim 11, wherein an area-normalized apparent capacitance decreases rapidly with increasing the density of point and line defects.

16. The energy storage device of claim 11, wherein the maximum area-normalized apparent capacitance is achieved at a point defect density of about 4×10¹² to about 5×10¹² cm⁻² and line defect density of about 4×10¹² cm⁻².

17. The energy storage device of claim 11, wherein the carbon film has a porous structure for increasing the total surface area.

18. The energy storage device of claim 11, wherein the fully disordered sp² carbon material undergoes processes that provide thermal energy to the lattice structure of the carbon-based electrode.

19. The fully disordered sp² carbon material of claim 18, wherein the densities of point and line defects approach the optimal densities for maximization of area-normalized capacitance.

20. The energy storage device of claim 11, wherein optimization of the defect densities can occur at any point during the electrode or device manufacturing.

21. A distributed model that predicts the area-normalized apparent capacitance of sp²-hybridized carbon materials in stage (i) of graphene amorphization trajectory from the density of point and line defects.

22. The distributed model of claim 21, wherein the apparent capacitance increases in proportion to the defect parameter N_{D}.

23. The distributed model of claim 21, wherein the defect parameter N_{D} is estimated by:
$${( {L}_{D}^{2} + \frac{{L}_{a}^{2}}{2} )}^{- 1} = {N}_{D} .$$

24. The distributed model of claim 21, wherein Lₐ is the average crystallite size of the graphitic film.

25. The distributed model of claim 21, wherein L_{D} is the average distance between point defects in the graphitic film.
